(19) United States
(12) Patent Application Publication
(10) Pub. No.: US 2025/0116950 A1
(43) Pub. Date: Apr. 10, 2025

(54) TONER

(71) Applicant: CANON KABUSHIKI KAISHA, Tokyo (JP)

(72) Inventors: TORU TAKAHASHI, Ibaraki (JP); ICHIRO KANNO, Chiba (JP); RYUICHIRO MATSUO, Ibaraki (JP); HITOSHI SANO, Chiba (JP); MARI KABURAGI, Chiba (JP); HAYATO IDA, Ibaraki (JP); YUYA CHIMOTO, Chiba (JP)

(21) Appl. No.: 18/905,604

(22) Filed: Oct. 3, 2024

(30) Foreign Application Priority Data
Oct. 6, 2023 (JP) 2023-173998

(51) Int. Cl. G03G 9/097; G03G 9/08

(52) U.S. Cl. CPC G03G 9/09725; G03G 9/0819; G03G 9/0821; G03G 9/09716; G03G 9/09775

(57) ABSTRACT

A toner contains toner particles and an external additive on the surfaces of the toner particles. The external additive includes composite fine particles that include fine particles A containing an organosilicon compound with siloxane bonds as a binder component and fine particles B at least partially embedded in the surfaces of the fine particles A with an embedding rate of 30% to 90% on average, and fine particles C including titanium oxide or titanic acid compound fine particles and having a volume resistivity of 2.0×10⁹ to 2.0×10¹³ Ω·cm and a number average diameter of primary particles of 10 to 100 nm. The organosilicon compound contains bifunctional, trifunctional, and tetrafunctional silane monomers with specific relationships. The number average diameter X of primary particles of the composite fine particles and the number average diameter Y of primary particles of fine particles C satisfy 1.0≤X/Y≤10.0.

### BACKGROUND

### Field

The present disclosure relates to a toner used in electrophotographic methods, electrostatic recording methods, electrostatic printing methods, and the like.

### Description of the Related Art

Electrophotographic full-color copiers have been widely used and have begun to be applied to the printing market. The printing market is increasingly requiring high image quality and high stability along with high-speed printing.

In order to increase image quality, the charge properties of toner should be stabilized. In order to stabilize the charge properties of toner, various studies have been conducted on external additives. For example, Japanese Patent Laid-Open No. 2022-28076 discloses a toner to which a low-resistance titanium-based compound is externally added to reduce the likelihood of being excessively charged while reducing the occurrence of fogging during continuous output.

The charge stability of toner depends on the properties of the charge-applying members, such as the developing roller and the carrier, as well as the properties of the toner. The charge-applying members come into contact with toner to apply charge to the toner. Therefore, toner components may attach to the charge-applying members.

If a low-resistance titanium-based compound, as described in Japanese Patent Laid-Open No. 2022-28076, attaches to a charge-applying member, the ability of the member to apply charge to the toner is reduced. In particular, if the charging properties are degraded in high-temperature, high-humidity environments, where triboelectrification is less likely to occur, the electrostatic adhesion between the charge-applying members and the toner decreases.

As printing speed increases with the demand for higher speed, toner becomes easy to remove from the charge-applying members and scatter and can soil the inside of the apparatus. In addition, as the amount of charge decreases, dot reproductivity for faithfully reproducing latent images, which is important for increasing image quality, deteriorates.

Further improvement is required to reduce the overcharge of toner and improve dot reproducibility while reducing the scattering of toner over a long period, even in high-temperature, high-humidity environments.

### SUMMARY

Accordingly, the present disclosure provides a toner containing toner particles and an external additive on the surface of the toner particles. The external additive includes composite fine particles, and fine particles C including either titanium oxide fine particles or titanic acid compound fine particles and having a volume resistivity of 2.0×10⁹ Ω·cm to 2.0×10¹³ Ω·cm and a number average diameter of primary particles of 10 nm to 100 nm. The composite fine particles include fine particles A containing an organosilicon compound with siloxane bonds as a binder component, and fine particles B, at the surfaces of the composite fine particles, in a state at least partially embedded in the surfaces of the fine particles A. The fine particles A satisfy the following relationships (1) to (3):

$$P a + P b + P c \geq 0.8 ; \qquad ( 1 )$$

$$Pb + P c \geq 0.3 ; and \qquad ( 2 )$$

$$P a / ( P a + Pb + Pc ) \leq 0.7 , \qquad ( 3 )$$

wherein Pa represents the proportion of silicon atoms expressed as Si^{a} in the structure represented by the following unit (a) relative to the total silicon atoms contained in the organosilicon compound, Pb represents the proportion of silicon atoms expressed as Si^{b} in the structure represented by the following unit (b) relative to the total silicon atoms contained in the organosilicon compound, and Pc represents the proportion of silicon atoms expressed as Si^{c} in the structure represented by the following unit (c) relative to the total silicon atoms contained in the organosilicon compound:

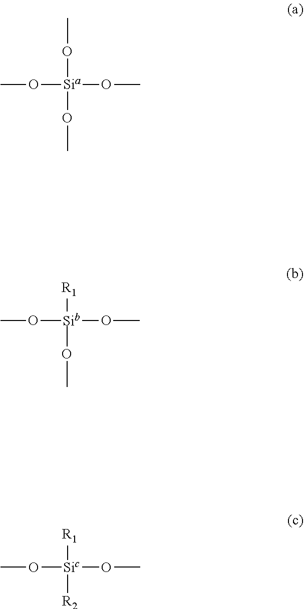

wherein R₁ and R₂ each represent an alkyl group with 1 to 6 carbon atoms. The average of the embedding rate of the fine particles B in the fine particles A represented by the following equation is 30% to 90%:

$$Embedding rate ( \% ) of the fine particles B = ( depth of the fine particles B embedded in the fine particles A ) / ( diameter of fine particles B ) \times 100$$

The number average diameter X of primary particles of the composite fine particles and the number average diameter Y of primary particles of the fine particles C satisfy the relationship: 1.0≤X/Y≤10.0.

Further features of the present disclosure will become apparent from the following description of exemplary embodiments.

### DESCRIPTION OF THE EMBODIMENTS

In the description presented herein, numerical ranges expressed as “in the range of ** to xx” or “** to xx” each include the lower and the upper limit being the values at the ends of the range unless otherwise specified. The toner disclosed herein includes toner particles and an external additive for the toner, and in the following description, the toner particles are also referred to as “toner base particles”.

### Features of the Present Disclosure

The present inventors believe the reasons for the effectiveness of the inventive concept disclosed herein are as follows.

In order to reduce the overcharge of toner to improve image quality, titanium oxide or titanic acid compound fine particles (fine particles C) with a volume resistivity of 2.0×10⁹ Ω·cm to 2.0×10¹³ Ω·cm and a number average diameter of primary particles of 10 nm to 100 nm should be externally added. This external addition provides a sharp charge distribution and high-quality images.

However, when the titanium oxide or titanic acid compound fine particles accumulate on the charge-applying members, such as the developing roller and the carrier, over a long period of use, the accumulated fine particles interfere with the triboelectrification between the toner and the charge-applying members, degrading image quality and causing the toner to scatter.

The present inventors have conducted a diligent study to reduce contamination of charge-applying members and identified that the external addition of the composite fine particles disclosed herein together with the fine particles C reduces the overcharge of the toner over a long period to improve image quality and reduces the scattering of the toner over a long period even in high-temperature, high-humidity environments, enabling consistent production of high-quality images.

The composite fine particles are an external additive including fine particles A whose surface has protrusions resulting from the presence of fine particles B. When the average of the embedding rate of the fine particles B in the fine particles A is 30% to 90%, probably, the protrusions are more likely to come into contact with fine particles C, thus scraping the fine particles C attached to the charge-applying members effectively.

However, the scraping effect is not sufficiently produced only by the protrusions of the composite fine particles, and the relationship in particle size between the composite fine particles and the fine particles C is important.

More specifically, the number average diameter X of primary particles of the composite fine particles and the number average diameter Y of the fine particles C are required to satisfy the relationship: 1.0≤X/Y≤10.0.

When X/Y is in such a range, the contamination of the charge-applying members by titanium oxide or titanic acid compound fine particles can be reduced effectively, and thus, the scattering of the toner can be reduced over a long period even in high-temperature, high-humidity environments, enabling consistent production of high-quality images. From the viewpoint of producing the above-described effects, it is desirable to satisfy 2.4≤X/Y≤6.0.

Furthermore, the composite fine particles include fine particles A containing an organosilicon compound with siloxane bonds as a binder component.

The composite fine particles also include, at the surfaces thereof, fine particles B that are at least partially embedded in the surfaces of the fine particles A.

The fine particles A are required to satisfy the following relationships (1) to (3):

$$P a + P b + P c \geq 0.8 ; \qquad ( 1 )$$

$$Pb + P c \geq 0.3 ; and \qquad ( 2 )$$

$$P a / ( P a + Pb + Pc ) \leq 0.7 . \qquad ( 3 )$$

In the relationships, Pa represents the proportion of silicon atoms expressed as Si^{a} in the structure represented by the following unit (a) relative to the total silicon atoms contained in the organosilicon compound, Pb represents the proportion of silicon atoms expressed as Si^{b} in the structure represented by the following unit (b) relative to the total silicon atoms contained in the organosilicon compound, and Pc represents the proportion of silicon atoms expressed as Si^{c} in the structure represented by the following unit (c) relative to the total silicon atoms contained in the organosilicon compound.

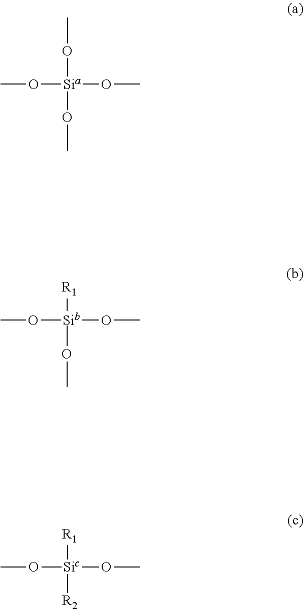

(R₁ and R₂ each represent an alkyl group with 1 to 6 carbon atoms.)

The composite fine particles containing a compound having such a composition are difficult to break when the toner is stressed by the carrier or other members and have moderate flexibility, which prevents the composite fine particles from being embedded in the toner and enables them to maintain their effectiveness on the toner surface. Consequently, the composite fine particles produce the effect of scraping the fine particles C attached to the charge-applying members even after a long period of use in high-temperature, high-humidity environments, thus reducing the overcharge of the toner to improve image quality and reduce the scattering of the toner in high-temperature, high-humidity environments over a long period.

### External Additive

The structure and production method of the external additive disclosed herein will now be described in detail.

### Composite Fine Particles

For the proportions Pa, Pb, and Pc of the above-presented units (a), (b), and (c) in the composite fine particles, Pb+Pc may be 0.55 or more and Pa/(Pa+Pb+Pc) may be 0.45 or less, from the viewpoint of preventing the composite fine particles from being embedded in the toner. These proportions can be controlled by the amounts of addition of alkoxysilane with the respective structures.

The number average diameter of primary particles of the composite fine particles may be 0.03 μm to 0.30 μm, for example, 0.06 μm to 0.30 μm. When the number average diameter of primary particles is in such a range, the external additive, which is composed of fine particles, can evenly cover the toner particles. Also, the fine particles C are likely to be scraped.

The number average diameter of primary particles of the composite fine particles can be increased by lowering the reaction temperature, shortening the reaction time, or increasing the amount of catalyst, in the hydrolysis and condensation steps. Also, the number average diameter of primary particles of the composite fine particles can be reduced by raising the reaction temperature, lengthening the reaction time, or reducing the amount of catalyst, in the hydrolysis and condensation steps.

The fine particles B are at least partially embedded in the surfaces of the fine particles A, and the embedding rate is 30% to 90% on average. The embedding rate of the fine particles B can be controlled by the time and temperature of the reaction with alkoxysilane with the above-presented structures (a) to (c). For reducing the embedding rate, the time or temperature of the reaction between alkoxysilane and the fine particles B may be reduced. For increasing the embedding rate, the time or temperature of the reaction between alkoxysilane and the fine particles B may be increased.

If fine particles containing an organosilicon compound with siloxane bonds as a binder component but not having protrusions resulting from the presence of the fine particles B are used as the external additive of the toner, the desired scraping effect derived from the protrusions cannot be produced, and accordingly, the contamination of the charge-applying members cannot be reduced. Fine particles containing an organosilicon compound as a binder component with fine particles B fully embedded therein are an example of fine particles having no protrusions. Such fine particles also cannot reduce the contamination of the charge-applying members for the same reason.

The measurement methods of the above-mentioned physical properties will be described later.

### Production Method

The composite fine particles disclosed herein may be produced by, but not limited to, a sol-gel method through the hydrolysis and condensation polymerization of a silicon compound (silane monomer). For example, a mixture of bifunctional silane with two siloxane bonds and tetrafunctional silane with four siloxane bonds may be subjected to hydrolysis and condensation polymerization, and the resulting system is allowed to react with colloidal silica or the like equivalent to the fine particles B to form composite fine particles. Silane monomers, including bifunctional silane and tetrafunctional silane, will be described later. The proportion of bifunctional silane may be 30% by mole to 70% by mole, for example, 40% by mole to 60% by mole. The proportion of tetrafunctional silane may be 30% by mole to 80% by mole, for example, 40% by mole to 70% by mole.

The composite fine particles disclosed herein include particles containing an organosilicon compound with siloxane bonds as the binder (fine particles A) as the major component.

The organosilicon compound disclosed herein may be produced by any process without limitation. For example, a silane compound dropped in water is subjected to hydrolysis and condensation in the presence of a catalyst, and the resulting suspension is filtered and dried to yield an organosilicon compound. The particle size can be controlled by varying the type and amount of the catalyst, the temperature at which the reaction starts, the time of dropping, and other factors. Examples of the catalyst include, but are not limited to, acid catalysts, such as hydrochloric acid, hydrofluoric acid, sulfuric acid, and nitric acid; and basic catalysts, such as ammonia water, sodium hydroxide, and potassium hydroxide.

In some embodiments, the organosilicon compound used herein is produced in the following process. Specifically, the process may include:
a first step of producing a hydrolysate of a silicon compound,
a second step of mixing the hydrolysate, an alkaline aqueous medium, and colloidal silica for a polycondensation reaction of the hydrolysate and a subsequent reaction with colloidal silica, and
a third step of mixing the polycondensation product with an aqueous solution to form particles.
   In some cases, a hydrophobizing agent may further be added.

In the first step, an acid or alkaline material that acts as the catalyst is dissolved in water, and in this solution, a silicon compound is brought into contact with the catalyst by stirring, blending, or the like. Any known catalyst may be used. Examples of the catalyst include acid catalysts, such as acetic acid, hydrochloric acid, hydrofluoric acid, sulfuric acid, and nitric acid; and basic catalysts, such as ammonia water, sodium hydroxide, and potassium hydroxide.

The amount of catalyst can be adjusted according to the types of the silicon compound and the catalyst. For example, it may be 1×10⁻³ parts to 1 part by mass relative to 100 parts by mass of water used for hydrolyzing the silicon compound.

When the amount of catalyst is 1×10⁻³ parts by mass or more, the reaction proceeds sufficiently. When the amount of catalyst is 1 part by mass or less, the concentration of the catalyst remaining as impurities in the fine particles is reduced, facilitating the hydrolysis. The amount of water may be 2 mol to 15 mol per mole of silicon compound. When the amount of water is 2 mol or more, the hydrolysis proceeds sufficiently, and when it is 15 mol or less, the productivity increases.

The reaction may be performed, but not limited to, at room temperature or under heating conditions. In some embodiments, the reaction temperature is kept at 10° C. to 60° C. from the viewpoint of obtaining a hydrolysate in a short time and reducing the partial condensation of the hydrolysate. The reaction time is not particularly limited and can be determined as appropriate in consideration of the reactivity of the silicon compound to be used, the composition of the reaction liquid containing the silicon compound, acid, and water, and productivity.

In the second step of the method for producing the organosilicon compound particles, the raw material solution obtained in the first step is mixed with an alkaline aqueous medium for a polycondensation reaction of the particle precursor to obtain a polycondensed liquid. The alkaline aqueous medium is prepared by mixing an alkaline component, water, and optionally an organic solvent and the like.

The alkaline component used in the alkaline aqueous medium, which is a substance whose aqueous solution is basic, acts as a neutralizer for the catalyst used in the first step and as a catalyst for the polycondensation reaction in the second step. Examples of the alkaline component include alkali metal hydroxides, such as lithium hydroxide, sodium hydroxide, and potassium hydroxide; ammonia; and organic amines, such as monomethylamine and dimethylamine.

The amount of the alkaline component is determined so that the alkaline component can neutralize the acid and act effectively as a catalyst for the polycondensation reaction. For example, in the case of using ammonia as the alkaline component, 0.01 parts to 12.5 parts by mass of ammonia is used relative to 100 parts by mass of the mixture of water and organic solvent.

In the second step, an organic solvent may also be used in addition to the alkaline component and water to prepare the alkaline aqueous medium. Any organic solvent can be used without limitation as long as it is compatible with water, but organic solvents that dissolve at least 10 g of water in 100 g at room temperature and under normal pressure may be suitable.

More specifically, such organic solvents include alcohols, such as methanol, ethanol, n-propanol, 2-propanol, and butanol; polyhydric alcohols, such as ethylene glycol, diethylene glycol, propylene glycol, glycerin, trimethylolpropane, and hexanetriol; and ethers, such as ethylene glycol monoethyl ether, acetone, diethyl ether, tetrahydrofuran, and diacetone alcohol; and amide compounds, such as dimethylformamide, dimethylacetamide, and N-methylpyrrolidone.

Among these organic solvents, alcohols, such as methanol, ethanol, 2-propanol, and butanol may be beneficial. In some embodiments, the same alcohol as the alcohol produced by elimination is used as the organic solvent in view of hydrolysis and dehydration condensation reactions.

In the third step, the polycondensation product obtained in the second step is mixed with an aqueous solution to form particles. The aqueous solution may be water (tap water, pure water, etc.), and further constituents compatible with water, such as a salt, an acid, an alkali, an organic solvent, a surfactant, a water-soluble polymer, may be added to water. The temperature of the polycondensed liquid and aqueous solution when mixed may be, but is not limited to, 5° C. to 70° C. in view of their compositions and productivity.

For collecting the resulting particles, any known method may be used without particular limitation. For example, the particles may be collected by scooping floating powder or filtration. Filtration may be advantageous because of its simple operation. The filtration may be performed by, but not limited to, vacuum filtration, centrifugal filtration, pressure filtration, or any other method using known devices. The filter used for the filtration may be a filter paper, a filter cloth, or any other type of filter, and can be selected, without particular limitation, from industrially available filters as appropriate for the device used.

### Silane Monomers

The monomers to be used may be selected as appropriate according to compatibility with the solvent and catalyst, hydrolyzability, and other properties. Examples of the tetrafunctional silane monomer having the above structure (a) include tetramethoxysilane, tetraethoxysilane, and tetraisocyanatosilane, particularly tetraethoxysilane.

Examples of the trifunctional silane monomer having the above structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, Propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane, particularly methyltrimethoxysilane.

Examples of the bifunctional silane monomer having the above structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane, particularly dimethyldimethoxysilane.

### Other Physical Properties of Composite Fine Particles

The absolute specific gravity of the composite fine particles disclosed herein may be 1.00 g/cm³ to 1.60 g/cm³. When it is in such a range, the external additive is less likely to be embedded in the surfaces of the toner particles when the toner is stressed by the carrier and other members. This is beneficial from the viewpoint of reducing the contamination of the charge-applying members. The absolute specific gravity of the external additive can be controlled by the amount of fine particles B added. In some embodiments, the absolute specific gravity of the composite fine particles may be 1.35 g/cm³ to 1.55 g/cm³.

For the composite fine particles disclosed herein, when an electron micrograph of cross sections of the fine particles A is taken using a transmission electron microscope, the average of Sb/Sa values of 100 fine particles A may be 0.00 to 0.50, wherein Sa is the area of the cross section X of an individual fine particle A, and Sb is the total area of the fine particles B fully contained within the cross section X without being exposed outside. In this instance, the external additive is less likely to be embedded in the surfaces of the toner particles when the toner is stressed by carriers and other members. Therefore, such composite fine particles are beneficial from the viewpoint of reducing the contamination of the charge-applying members. The Sb/Sa value can be controlled by the amount of fine particles B added and the time and temperature of the reaction of the fine particles B with the monomers forming the fine particles A.

In the composite fine particles, the ratio BD/AD of the number average diameter BD of primary particles of the fine particles B to the number average diameter AD of primary particles of the fine particles A may be in the range of 0.05 to 0.70. When it is in such a range, the composite fine particles have the scraping effect more effectively. The number average diameter of primary particles of the fine particles A can be controlled by controlling the reaction conditions in the hydrolysis and condensation steps as described above. The number average diameter of primary particles of the fine particles B can be controlled by the selection of the fine particles added.

The fine particles B of the composite fine particles disclosed herein may be silica or alumina fine particles. Such fine particles have hardness suitable as the fine particles B and are beneficial in terms of reducing the contamination of the charge-applying members and also having stability in durability. In some embodiments, silica fine particles may be selected from the viewpoint of the reactivity with the binder component of the fine particles A. The silica fine particles used herein, which contain silica (SiO₂) as the main constituent, may be produced using silica compounds, such as water glass or alkoxysilane, as the raw material or produced by pulverizing quartz.

Examples of the silica fine particles include silica particles produced by a sol-gel method, precipitated silica particles produced by precipitation, aqueous colloidal silica particles, fumed silica particles produced in a gas-phase process, and fused silica particles. From the viewpoint of the reactivity with the binder component and dispersion stability, aqueous colloidal silica particles may be used. Aqueous colloidal silica particles may be obtained commercially or prepared by known processes using a variety of starting materials. For example, aqueous colloidal silica particles may be produced from silicic acid derived from an alkaline silicate solution with a pH of about 9 to 11, and silicate anions form silica particles with a desired particle size in the form of an aqueous dispersion liquid through polymerization.

The composite fine particles disclosed herein may be surface treated with a hydrophobizing agent. The hydrophobizing agent may be, but is not limited to, an organosilicon compound. Examples of the hydrophobizing agent include alkylsilazane compounds, such as hexamethyldisilazane; alkylalkoxysilane compounds, such as diethyldiethoxysilane, trimethylmethoxysilane, methyltrimethoxysilane, and butyltrimethoxysilane; fluoroalkylsilane compounds, such as trifluoropropyltrimethoxysilane; chlorosilane compounds, such as dimethyldichlorosilane and trimethylchlorosilane; siloxane compounds, such as octamethylcyclotetrasiloxane, and silicone oil and silicone varnish.

Hydrophobization of the surface of the composite fine particles can reduce the change in electrostatic adhesion of the toner after the durability test. In some embodiments, the composite fine particles are surface treated with at least one compound selected from the group consisting of alkylsilazane compounds, alkylalkoxysilane compounds, chlorosilane compounds, siloxane compounds, and silicone oil. Particularly, alkylsilazane compounds are beneficial in terms of the above-mentioned viewpoint.

The amount of the composite fine particles disclosed herein may be 0.1 parts to 20.0 parts by mass relative to 100 parts of the toner particles from the viewpoint of charge stability and, in some embodiments, may be 0.5 parts to 15.0 parts by mass or 1.0 part to 10.0 parts by mass. Such an amount of composite fine particles can be present sufficiently over the surfaces of the toner particles, producing the effect of reducing the contamination of the charge-applying members.

### Fine Particles C

The fine particles C are either titanium oxide fine particles or titanic acid compound fine particles and have a volume resistivity of 2.0×10⁹ Ω·cm to 2.0×10¹³ Ω·cm and a number average diameter of primary particles of 10 nm to 100 nm.

Such fine particles C can control the charge distribution of the toner to be sharp.

The number average diameter of primary particles of the fine particles C may be 20 nm to 60 nm or 20 nm to 50 nm. The number average diameter of primary particles can be controlled by the concentration, the reaction temperature, and the reaction time of the raw material.

The volume resistivity of the fine particles C may be 1.0×10¹⁰ Ω·cm to 5.0×10¹² Ω·cm or 1.0×10¹⁰ Ω·cm to 3.5×10¹¹ Ω·cm. By controlling the number average diameter of primary particles and volume resistivity of the fine particles C in the above ranges, the charge distribution of the toner can be controlled to be sharp, thereby improving the dot reproductivity and reducing scattering of the toner.

The amount of the fine particles C may be 0.05 parts to 2.0 parts by mass, for example, 0.2 parts to 1.7 parts by mass, relative to 100 parts by mass of the toner particles.

The amount of the composite fine particles added (W) to the amount of the fine particles C added (WC) satisfies 5.0≤W/WC≤20.0, for example, 6.0≤W/WC≤10.0. When their proportion is in such a range, the composite fine particles and the fine particles C can function effectively to improve dot reproductivity and reduce the scattering of the toner.

When the fine particles C are titanium oxide fine particles, any known titanium oxide fine particles can be used as long as the volume resistivity and the number average diameter of primary particles are in the above ranges.

The crystals of the titanium oxide fine particles may be in either the rutile or anatase form.

In some embodiments, the fine particles C are titanic acid compound fine particles. The titanic acid compound fine particles may be made of potassium titanate, barium titanate, strontium titanate, calcium titanate, magnesium titanate, lead titanate, aluminum titanate, lithium titanate, or any other titanate. Strontium titanate and calcium titanate are beneficial in terms of obtaining a desired charge distribution.

The fine particles C may exhibit a CuKα X-ray diffraction spectrum having the highest peak at a diffraction angle (2θ) of 32.00 degrees to 32.40 degrees, and the half width of the highest peak may be 0.23 degrees to 0.50 degrees. Such fine particles C improve dot reproductivity.

The fine particles C may be surface treated for hydrophobization or controlling triboelectric chargeability or volume resistivity, as needed. Examples of such surface a treatment agent include unmodified silicone varnish, variously modified silicone varnishes, unmodified silicone oil, variously modified silicone oils, silane coupling agents, silane compounds with functional groups, and other organosilicon compounds. Some types of treatment agents may be used in combination. In some embodiments, the fine particles C are treated with a silane coupling agent. In other words, the fine particles C may be titanic acid compound fine particles surface treated with a silane coupling agent.

Examples of the silane coupling agent include vinyltrimethoxysilane, vinyltriethoxysilane, vinyltris(β-methoxyethoxy) silane, β-(3,4-epoxycyclohexyl)ethyltrimethoxysilane, γ-glycidoxypropyltrimethoxysilane, γ glycidoxypropylmethyldiethoxysilane, γ-aminopropyltrimethoxysilane, N-phenyl-γ-aminopropyltrimethoxysilane, γ-methacryloxypropyltrimethoxysilane, vinyltriacetoxysilane, methyltrimethoxysilane, dimethyldimethoxysilane, phenyltrimethoxysilane, diphenyldimethoxysilane, methyltriethoxysilane, dimethyldiethoxysilane, phenyltriethoxysilane, diphenyldiethoxysilane, n-butyltrimethoxysilane, isobutyltrimethoxysilane, trimethylmethoxysilane, n-hexyltrimethoxysilane, n-octyltrimethoxysilane, n-octyltriethoxysilane, n-decyltrimethoxysilane, hydroxypropyltrimethoxysilane, n-hexadecyltrimethoxysilane, n-octadecyltrimethoxysilane, trifluoropropyltrimethoxysilane, and hydrolysate thereof.

In some embodiments, n-octyltriethoxysilane, isobutyltrimethoxysilane, or trifluoropropyltrimethoxysilane, particularly isobutyltrimethoxysilane, may be selected. Treatment agents may be used individually or in combination.

The titanic acid compound fine particles may be doped with metallic elements other than the metallic element of the titanate. Examples of the metallic elements used for doping include, but are not limited to, lanthanum, silicon, aluminum, magnesium, calcium, manganese, rhodium, ruthenium, iridium, tantalum, chromium, antimony, nickel, and niobium. Lanthanum is useful in controlling circularity.

The titanic acid compound fine particles may be produced by any method without limitation. For strontium titanate, for example, the following process may be used. A titanyl sulfate solution is hydrolyzed to prepare a hydrous titanium oxide slurry, followed by adjusting the pH to obtain a titania sol dispersion liquid. Then, strontium nitrate, strontium chloride, or the like is added to the dispersion liquid, and after heating to a reaction temperature, an alkaline aqueous solution is added for synthesis. The reaction temperature may be 60° C. to 100° C.

In the operation of adding the alkaline aqueous solution to control the number average diameter of primary particles, the time for this operation may be 60 minutes or less. Also, ultrasonic vibration may be applied during adding the alkaline aqueous solution from the viewpoint of controlling circularity.

The aqueous solution after the completion of the reaction by adding the alkaline aqueous solution may be rapidly cooled from the viewpoint of controlling the primary particle diameter and circularity. For rapid cooling, for example, pure water cooled to 10° C. or less may be added to a desired temperature. Rapid cooling can control the circularity to be high.

### Constituents of Toner Particles

The constituents of the toner particles disclosed herein will now be described in detail.

### Binder Resin

The toner particles contain a binder resin, and any known binder resin may be used in the toner particles. Examples of the binder resin include
styrene resins, styrene copolymer resin, polyester resin, polyol resin, polyvinyl chloride resin, phenolic resin, natural resin modified phenolic resin, natural resin modified maleic acid resin, acrylic resin, methacrylic resin, polyvinyl acetate, silicone resin, polyurethane resin, polyamide resin, furan resin, epoxy resin, xylene resin, polyvinyl butyral, terpene resin, coumarone-indene resin, and petroleum-based resin. Among these, styrene copolymer resin, polyester resin, and mixtures or hybrid resin of polyester resin and styrene copolymer resin may be more beneficial. In some embodiments, polyester resin is used.

### Polyester Resin

The components of polyester resin will be described in detail below. The following component materials may be used individually or in combination according to the type and use.

Polyester resin contains divalent carboxylic acid components. Examples include dicarboxylic acids and their derivatives, for example, benzenedicarboxylic acids and their anhydrides or lower alkyl esters, such as phthalic acid, terephthalic acid, isophthalic acid, and phthalic anhydride; alkyldicarboxylic acids and their anhydrides or lower alkyl esters, such as succinic acid, adipic acid, sebacic acid, and azelaic acid; alkenylsuccinic or alkylsuccinic acids with 1 to 50 carbon atoms on average and their anhydrides or lower alkyl esters; unsaturated dicarboxylic acids and their anhydrides or lower alkyl esters, such as fumaric acid, maleic acid, citraconic acid, and itaconic acid.

The alkyl group of lower alkyl esters may be methyl, ethyl, propyl, or isopropyl.

Dihydric alcohol components of the polyester resin include, for example, ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6 hexanediol, neopentyl glycol, 2-methyl-1,3-propanediol, 2-ethyl-1,3-hexanediol, 1,4-cyclohexanedimethanol (CHDM), hydrogenated bisphenol A, bisphenols represented by formula (I-1) and their derivatives, and diols represented by formula (I-2):

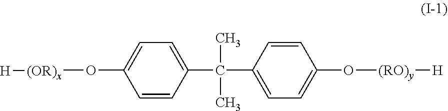

(In formula (I-1), R represents an ethylene or propylene group, x and y are each an integer of 0 or more, and the average of x+y is 0 to 10.)

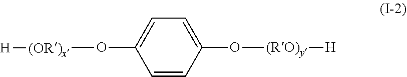

(In formula (I-2), R′ represents an ethylene or propylene group, x′ and y′ are each an integer of 0 or more, and the average of x′+y′ is 0 to 10.)

The polyester resin may further contain trivalent or higher valent carboxylic acid components and trihydric or higher polyhydric alcohol components in addition to the dicarboxylic acid component and dihydric alcohol component.

Examples of trivalent or higher valent carboxylic acid components include, but are not limited to, trimellitic acid, trimellitic anhydride, and pyromellitic acid. Examples of trihydric or higher polyhydric alcohol components include trimethylolpropane, pentaerythritol, and glycerin.

The polyester resin may contain monovalent carboxylic acid components and monohydric alcohol components in addition to the above components. Examples of monovalent carboxylic acid components include palmitic acid, stearic acid, arachidic acid, behenic acid, cerotic acid, heptacosanic acid, montanic acid, melissic acid, lacceric acid, tetracontanoic acid, and pentacontanoic acid.

Also, examples of monohydric alcohol components include behenyl alcohol, ceryl alcohol, melissyl alcohol, and tetracontanol.

### Coloring Agent

The toner may be used as any of the magnetic single-component toner, nonmagnetic single-component toner, and nonmagnetic two-component toner.

When the toner is used as a magnetic single-component toner, magnetic iron oxide particles may be used as the coloring agent. Exemplified materials of the magnetic iron oxide particles contained in the magnetic single-component toner include magnetic iron oxides, such as magnetite, maghemite, and ferrite, and magnetic iron oxides containing other metal oxides; metals such as Fe, Co, and Ni and their alloys with Al, Co, Cu, Pb, Mg, Ni, Sn, Zn, Sb, Be, Bi, Cd, Ca, Mn, Se, Ti, W, or V; and mixture thereof. The amount of magnetic iron oxide particles may be 30 parts to 150 parts by mass relative to 100 parts by mass of the binder resin.

When the toner is used as a nonmagnetic single-component toner or nonmagnetic two-component toner, the following may be used as the coloring agent.

Example of black pigment include carbon blacks, such as furnace black, channel black, acetylene black, thermal black, and lamp black; and magnetic powder, such as magnetite and ferrite.

For yellow color, pigments or dyes may be used. Examples of yellow pigment include C.I. Pigment Yellows 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, and 191; and C.I. Vat Yellows 1, 3, and 20. Examples of yellow dye include C.I. Solvent Yellows 19, 44, 77, 79, 81, 82, 93, 98, 103, 104, 112, and 162. Such coloring agents may be used individually or in combination.

For cyan color, pigments or dyes may be used. Examples of cyan pigment include C.I. Pigment Blues 1, 7, 15, 15:1, 15:2, 15:3, 15:4, 16, 17, 60, 62, and 66, C.I. Vat Blue 6, and C.I. Acid Blue 45. Examples of cyan dye include C.I. Solvent Blues 25, 36, 60, 70, 93, and 95. Such coloring agents may be used individually or in combination.

For magenta color, pigments or dyes may be used. Examples of magenta pigment include C. I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, and 254, C.I. Pigment Violet 19, and C.I. Vat Reds 1, 2, 10, 13, 15, 23, 29, and 35.

Examples of magenta dye include oil-soluble dyes, such as C.I. Solvent Reds 1, 3, 8, 23, 24, 25, 27, 30, 49, 52, 58, 63, 81, 82, 83, 84, 100, 109, 111, 121, and 122, C.I. Disperse Red 9, C.I. Solvent Violets 8, 13, 14, 21, and 27, and C.I. Disperse Violet 1; and basic dyes, such as C.I. basic reds 1, 2, 9, 12, 13, 14, 15, 17, 18, 22, 23, 24, 27, 29, 32, 34, 35, 36, 37, 38, 39, and 40, C.I. Basic Violets 1, 3, 7, 10, 14, 15, 21, 25, 26, 27, and 28. Such coloring agents may be used individually or in combination.

The amount of coloring agent may be 1 part to 20 parts by mass relative to 100 parts by mass of the binder resin.

### Release Agent

A release agent (wax) may be used to impart releasability to the toner.

Examples of wax include aliphatic hydrocarbon waxes, such as low-molecular-weight polyethylene, low-molecular-weight polypropylene, olefin copolymers, microcrystalline waxes, paraffin waxes, and Fischer-Tropsch waxes; oxides of aliphatic hydrocarbon waxes, such as polyethylene oxide waxes; waxes mainly containing fatty acid ester, such as carnauba wax, behenyl behenate wax, and montanate ester wax; and waxes with partially or entirely deoxidized fatty acid ester, such as deoxidized carnauba wax.

Further examples include saturated linear fatty acids, such as palmitic acid, stearic acid, and montanic acid; unsaturated fatty acids, such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols, such as sorbitol; fatty acid amides, such as linoleamide, oleamide, and lauramide; saturated fatty acid bisamides, such as methylene bis(stearamide), ethylene bis(capramide), ethylene bis(lauramide), and hexamethylene bis(lauramide); unsaturated fatty acid amides, such as ethylene bis(oleamide), hexamethylene bis(oleamide), N,N′-dioleyladipamide, and N,N′-dioleylsebacamide; aromatic bisamides, such as m-xylene bis(stearamide), N,N′-distearylisophthalamide; fatty acid metal salts (generally called metallic soap), such as calcium stearate, calcium laurate, Zinc Stearate, and magnesium stearate; aliphatic hydrocarbon-based waxes grafted with vinyl-based copoymerizable monomers such as styrene or acrylic acid; partial esters produced from fatty acids and polyhydric alcohols, such as behenic acid monoglyceride; and methyl ester compounds with hydroxy groups produced by hydrogenation of vegetable fats and oils.

In an embodiment, aliphatic hydrocarbon waxes may be used. Such waxes include, for example, low-molecular-weight hydrocarbons obtained by radical polymerization of alkylene under high pressure or by polymerization using Ziegler catalyst or metallocene catalyst under low pressure; Fischer-Tropsch wax synthesized from coal or natural gas; paraffin wax, olefin polymers produced by thermal decomposition of high-molecular weight olefin polymers; synthetic hydrocarbon waxes obtained from the distillation residue of hydrocarbons obtained from synthesis gas containing carbon monoxide and hydrogen by the Agee method; and synthetic hydtocarbon waxes produced by hydrogenation thereof.

In addition, hydrocarbon waxes fractionated by the press sweating method, solvent method, vacuum distillation, or fractional crystallization may also be used. In particular, n-paraffin waxes and Fischer-Tropsch waxes, which are paraffin waxes predominantly containing linear components, are beneficial in terms of molecular weight distribution.

The waxes cited above may be used individually or in combination. The amount of wax to be added may be 1 part to 20 parts by mass relative to 100 parts by mass of the binder resin.

### Charge Control Agent

The toner may contain a charge control agent. Known charge control agents can be used. Examples include azo iron compounds, azo chromium compounds, azo manganese compounds, azo cobalt compounds, azo zirconium compounds, chromium compounds of carboxylic acid derivatives, zinc compounds of carboxylic acid derivatives, aluminum compounds of carboxylic acid derivatives, and zirconium compounds of carboxylic acid derivatives. The carboxylic acid derivative may be an aromatic hydroxycarboxylic acid. Charge control resins may be used. An individual charge control agent or a combination of two or more charge control agents may be used, as needed. The amount of charge control agent may be 0.1 parts to 10 parts by mass relative to 100 parts by mass of the binder resin.

### Inorganic Fine Powder

The toner disclosed herein may contain multiple inorganic fine powders as needed apart from the toner external additive. The inorganic fine powder may be internally added into the toner particles or mixed with the toner base materials as an external additive. When used as an external additive, inorganic fine powder such as silica may be used. The inorganic fine powder may be hydrophobized with a hydrophobizing agent, such as a silane compound, silicone oil, or a mixture thereof.

When an external additive is used to improve flowability, inorganic fine powder with a specific surface area of 50 m²/g to 400 m²/g may be used. For improving flowability and stabilizing durability, inorganic fine particles with a specific surface area in the above range may be used in combination.

The amount of inorganic fine powder may be 0.1 parts to 10.0 parts by mass relative to 100 parts by mass of toner particles. When the proportion is in this range, durability tends to be stable.

### Production Method of Toner Particles

The toner particles may be produced in any known method without particular limitation. For example, pulverization, emulsion aggregation, suspension polymerization, or dissolution suspension may be used.

### Pulverization

In a pulverization method, the toner particles are produced as described below, for example.

A binder resin, a coloring agent, and optional additives are sufficiently mixed with a mixer, such as a Henschel mixer or a ball mill. The resulting mixture is melt-kneaded in a heat kneader, such as a twin screw kneader, a heating kneader, a kneader, or an extruder. At this time, wax, magnetic iron oxide particles, and a metal-containing compound may be added.

The melt-kneaded material is cooled to solidify and then pulverized and classified to yield toner particles. At this time, the embedding rate of the silica fine particles in the surfaces of the toner particles can be controlled by adjusting the exhaust temperature during pulverization. The toner particles and the external additive, such as silica fine particles, are mixed with a Henschel mixer, thus producing the toner.

Examples of the mixer include Henschel Mixer (manufactured by Nippon Coke & Engineering); Super Mixer (manufactured by Kawata), Ribocone (manufactured by Okawara MFG.); Nauta Mixer, Turbulizer, and Cyclomix (all manufactured by Hosokawa Micron); Spiral Pin Mixer (manufactured by Pacific Machinery & Engineering); and Loedige Mixer (manufactured by Matsubo).

Examples of screw kneaders include KRC Kneader (manufactured by Kurimoto); Buss Co-Kneader (manufactured by Buss); TEM Extruder (manufactured by Shibaura Machine); TEX Twin Screw Kneader (manufactured by Japan Steel Works); PCM kneader (manufactured by Ikegai); Three-Roll Mill, Mixing Roll Mill, and Kneader (all manufactured by Inoue MFG); Kneadex (manufactured by manufactured by Nippon Coke & Engineering); MS Pressure Kneader and Kneader-Ruder (both manufactured by Moriyama); and Banbury Mixer (manufactured by Kobe Steel).

Examples of pulverizers include Counter Jet Mill, Micron Jet, and Inomizer (all manufactured by Hosokawa Micron); IDS Mill and PJM Jet Mill (both manufactured by Nippon Pneumatic); Cross Jet Mill (manufactured by Kurimoto); ULMAX (manufactured by Nisso Engineering); SK Jet-O-Mill (manufactured by Seishin Enterprise); KRYPTRON (manufactured by Kawasaki Heavy Industries); Turbo Mill (manufactured by Freund Turbo); and Super Rotor (manufactured by Nisshin Engineering).

After pulverization, the toner particles may be surface-treated to control the embedding rate of silica fine particles in the surfaces of the toner particles using Hybridization system (manufactured by Nara Machinery), Nobilta (manufactured by Hosokawa Micron), Mechanofusion System (manufactured by Hosokawa Micron), Faculty (manufactured by Hosokawa Micron), Inomizer (manufactured by Hosokawa Micron), Theta Composer (manufactured by Tokuju Corporation), MECHANOMILL (manufactured by Okada Seiko), or Meteorainbow MR (manufactured by Nippon Pneumatic).

Examples of classifiers include Classiel, Micron Classifier, and Spedic Classifier (all manufactured by Seishin Enterprise); Turbo Classifier (manufactured by Nisshin Engineering); Micron Separator, Turboplex (ATP), and TSP Separator (all manufactured by Hosokawa Micron); Elbow-Jet (manufactured by Nittetsu Mining); Dispersion Separator (manufactured by Nippon Pneumatic); and YM Micro Cut (manufactured by Uras Techno).

Examples of sifters used to sift coarse particles include Ultrasonic (available from Kouei Industry); Resonasieve, and Gyaro-Sifter (manufactured by Tokuju Corporation); Vibrasonic System (manufactured by Dalton); Soniclean (manufactured by Sintokogio); Turbo Cleaner (manufactured by Freund-Turbo); Micro Sifter (manufactured by Makino Sangyo); and round-type vibrating screen separators.

### Emulsion Aggregation Process

In an emulsion aggregation methods, the toner particles are produced as described below, for example.

### Preparing Resin Fine Particle Dispersion Liquid (Dispersion Liquid Preparation Step):

For example, polyester resin, styrene resin, or acrylic resin is dissolved as a binder resin component in an organic solvent to prepare a homogeneous solution. Then, basic compounds and surfactant are added as needed. An aqueous medium is gradually added to the resulting solution while a shear force is applied with a homogenizer or the like to form resin fine particles of the binder resin. Finally, the organic solvent is removed to yield a resin fine particle dispersion liquid in which the resin fine particles are dispersed.

In the preparation of the resin fine particle dispersion liquid, the amount of resin component dissolved in the organic solvent may be 10 parts to 50 parts by mass, for example, 30 parts to 50 parts by mass, relative to 100 parts by mass of the organic solvent.

Any solvent that can dissolve the resin component can be used, but in some embodiments, solvents, such as toluene, xylene, and ethyl acetate, that are highly dissolvable to olefin resin may be used.

The surfactant is not limited. Examples of the surfactant include anionic surfactants, such as sulfuric ester salt-based surfactants, sulfonate-based surfactants, carboxylate-based surfactants, phosphoric ester-based surfactants, and soap-based surfactants; cationic surfactants, such as amine salt surfactants and quaternary ammonium salt-based surfactants; and nonionic surfactants, such as polyethylene glycol-based surfactants, alkylphenol ethylene oxide adduct-based surfactants, and polyhydric alcohol-based surfactants.

Examples of the basic compound include inorganic bases, such as sodium hydroxide and potassium hydroxide, and organic bases, such as triethylamine, trimethylamine, dimethylaminoethanol, and diethylaminoethanol. Such basic compounds may be used individually or in combination.

### Aggregation Step:

In the aggregation step, for example, the above-prepared resin fine particle dispersion liquid is mixed with a dispersion liquid of coloring agent fine particles, a dispersion liquid of wax fine particles, and a silicone oil emulsion, as needed, to prepare a mixture, and the fine particles in the mixture are aggregated to form aggregated particles.

For forming aggregated particles, for example, a flocculant is added to and mixed with the above mixture, followed by raising the temperature or adding mechanical power as appropriate.

The dispersion of coloring agent fine particles is prepared by dispersing the above-described coloring agent. The coloring agent fine particles can be dispersed by any known method, and, for example, a rotary shear homogenizer, a media dispersing device, such as a ball mill, a sand mill, or an attritor, a high-pressure counter collision disperser, or any other disperser may be used. In addition, a surfactant or a polymer dispersant may be added to impart dispersion stability as needed.

The dispersion liquid of wax fine particles and the silicone oil emulsion are prepared by dispersing the respective materials in aqueous media. Each material can be dispersed by any known method, and, for example, a rotary shear homogenizer, a media dispersing device, such as a ball mill, a sand mill, or an attritor, a high-pressure counter collision disperser, or any other disperser may be used. In addition, a surfactant or a polymer dispersant may be added to impart dispersion stability as needed.

Examples of the flocculant include monovalent metal salts, such as sodium and potassium salts; divalent metal salts, such as calcium and magnesium salts; trivalent metal salts, such as iron and aluminum salts; and multivalent metal salts, such as polyaluminum chloride. From the viewpoint of controlling the particle size in the aggregation step, divalent metal salts, such as calcium chloride and magnesium sulfate, may be used.

The addition and mixing of the flocculant may be performed at a temperature from room temperature to 75° C. When the mixing is performed at a temperature in this range, aggregation proceeds stably. The mixing step may be performed using a known mixing machine, such as a homogenizer or a mixer.

### Melting Step:

In the melting step, the aggregated particles are heated to, for example, a temperature of the melting point of the olefin resin or more to melt the particles, thus producing particles with smooth surfaces.

Before the melting step, a chelating agent, a pH adjuster, a surfactant, or the like may be added as needed to prevent the resin particles from fusing each other.

Examples of the chelating agent include ethylenediaminetetraacetic acid (EDTA) and its alkali metal salts, such as sodium salts, sodium gluconate, sodium tartrate, potassium citrate, and sodium citrate, nitrilotriacetate (NTA) salts, and water-soluble polymers (polyelectrolytes) with both functionalities of COOH and OH.

High-temperature heating shortens the time of the melting step, and low-temperature heating lengthens the time of the melting step. In other words, the time of heating and melting depends on the temperature of heating and is not generally specified, but is typically about 10 minutes to 10 hours.

### Cooling Step:

The aqueous medium containing the resin particles obtained in the melting step is cooled. Specifically, the cooling rate may be, but not limited to, about 0.1° C./min to 50° C./min.

### Washing Step:

The resulting resin particles obtained through the above steps are repeatedly washed and filtered to remove impurities from the resin particles.

More specifically, the resin particles may be washed with an aqueous solution containing a chelating agent, such as ethylenediaminetetraacetic acid (EDTA) or its sodium salt, and further with pure water.

The metal salt, surfactant, and the like in the resin particles can be removed by repeating pure water washing and filtration. The filtration may be performed 3 to 20 times, for example, 3 to 10 times, from the viewpoint of production efficiency.

### Drying and Classification Step:

The washed resin particles are dried and then classified as appropriate to yield toner particles.

### Dissolution Suspension

In a dissolution suspension method, the toner particles are produced as described below, for example.

In the dissolution suspension method, a resin composition prepared by dissolving a binder resin component, such as polyester resin or styrene acrylic resin, in an organic solvent is dispersed in an aqueous medium to from particles of the resin composition, and then the organic solvent in the particles of the resin composition is removed to yield toner particles.

Such a dissolution suspension method can be used for any resin component that dissolves in organic solvents and, in addition, enables easy shape control by the conditions in removing the solvent.

An exemplified method of producing the toner using dissolution suspension will be described below, but the method is not limited to the following.

### Resin Component Dissolving Step:

In this step, the binder resin and, optionally, other constituents, such as a coloring agent, wax, and silicone oil, are dissolved or dispersed in an organic solvent to prepare a resin composition.

The organic solvent can be any organic solvent that can dissolve the resin component. Specific examples include toluene, xylene, chloroform, methylene chloride, and ethyl acetate. In some embodiments, toluene or ethyl acetate may be used because these solvents can promote the crystallization of crystalline resin and are easy to remove.

The amount of the organic solvent used is not limited as long as the resin composition can be dispersed in a poor medium, such as water, to a viscosity that allows particles to be formed. More specifically, the mass ratio of the resin component and other optional constituents, including the coloring agent, wax, and silicone oil, to the organic solvent may be 10/90 to 50/50 from the viewpoint of easy particle formation and the efficiency of toner particle production.

The coloring agent, wax, and silicone oil are not necessarily dissolved in water and may be dispersed. When used in dispersion, the coloring agent, wax, and silicone oil may be dispersed using a disperser, such as a bead mill.

### Particle Formation Step:

In particle formation, the resulting resin composition is dispersed in an aqueous medium with a dispersant to prepare the resin composition particles so that the toner particles can have a predetermined particle size.

The aqueous medium is typically water.

The aqueous medium may contain 1% to 30% by mass of monovalent metal salt. The monovalent metal salt in the aqueous medium suppresses the diffusion of the organic solvent in the resin composition into the aqueous medium to increase the crystallinity of the resulting toner particles.

Consequently, the toner is likely to exhibit good anti-blocking property and good particle size distribution.

Examples of the monovalent metal salt include sodium chloride, potassium chloride, lithium chloride, and potassium bromide, and in some embodiments, sodium chloride or potassium chloride is used.

The mixing ratio (mass ratio) of the aqueous medium to the resin composition, aqueous medium/resin composition, may be 90/10 to 50/50.

The dispersant used is not limited, and a cationic, anionic, or nonionic surfactant, particularly anionic, may be used as an organic dispersant.

Specific examples include sodium alkylbenzenesulfonate, sodium α-olefinsulfonate, sodium alkylsulfonate, and sodium alkyldiphenyl ether disulfonate. Inorganic dispersant may also be used, and examples include tricalcium phosphate, hydroxyapatite, calcium carbonate fine particles, titanium dioxide fine particles, and silica fine particles.

In some embodiments, tricalcium phosphate, which is an inorganic dispersant, is used. This is because adverse effect of tricalcium phosphate on particle formation and its stability and, in addition, on the properties of the resulting toner is very small.

The amount of dispersant added is determined according to the particle size of the particles to be formed. The larger the amount of dispersant added, the smaller the particle size. Accordingly, in some embodiments, the amount of dispersant added may be 0.1% to 15.0% by mass relative to the mass of the resin composition but varies depending on the desired particle size.

The preparation of the resin composition particles in the aqueous medium may be performed with high-speed shearing. The apparatus for high-speed shearing may be a high-speed disperser or an ultrasonic disperser.

### Solvent Removal Step:

In solvent removal, the organic solvent contained in the resulting resin composition particles is removed to yield the toner particles. The removal of the organic solvent may be performed with stirring.

### Washing Drying and Classification Step:

After the solvent removal step, the toner particles may be washed with water or the like several times, followed by filtration and drying. If a dispersant soluble under acid conditions, for example, tricalcium phosphate, is used, the toner particles are desirably washed with hydrochloric acid and then water. Washing removes the dispersant used for forming particles. After washing, the particles are filtered, dried, and classified as appropriate to yield toner particles.

### Suspension Polymerization

In a suspension polymerization method, the toner particles are produced as described below, for example.

Polymerizable monomers that form the binder resin, a coloring agent, a wax component, and a polymerization initiator are uniformly dissolved or dispersed with a disperser, such as a homogenizer, a ball mill, an ultrasonic disperser, to prepare a polymerizable monomer composition. The polymerizable monomer composition is dispersed in an aqueous medium to form particles of the polymerizable monomer composition. Then, the polymerizable monomers in the particles of the polymerizable monomer composition are polymerized, thus forming toner particles.

The polymerizable monomer composition may be prepared by mixing a dispersion liquid in which the coloring agent is dispersed in a first polymerizable monomer (or a portion of a polymerizable monomer) with at least a second polymerizable monomer (or the rest of the polymerizable monomer). By sufficiently dispersing the coloring agent in the first polymerizable monomer and then mixing the dispersion liquid with the second polymerizable monomer together with other toner constituents, the coloring agent can be present in a well-dispersed state in the polymerized particles.

The resulting toner particles may be filtered, washed, dried, and classified as needed.

### Addition of External Additive to Toner Particles

The toner particles obtained by any of the above-described method and the external additive, are mixed together with a mixer such as a Henschel mixer to obtain the toner.

The toner may have a weight-average particle size (D4) of 4.0 μm to 15.0 μm. In some embodiments, the weight-average particle size of the toner is 4.0 μm to 9.0 μm or 6.0 μm to 8.0 μm

The weight-average particle size (D4) of the toner can be adjusted, for example, by classification of the toner particles.

### Developer

Although the toner disclosed herein can be used as a single-component developer, it may be mixed with a magnetic carrier to improve the dot reproductivity and thus used as a two-component developer, which is beneficial in terms of consistently providing images for a long period. The two-component developer contains a toner and a magnetic carrier, and the toner is desirably the toner disclosed herein.

When the toner is mixed with a magnetic carrier to be used as a two-component developer, the toner content of the two-component developer may be 2% to 15% by mass, for example, 4% to 13% by mass.

### Magnetic Carrier

The magnetic carrier may be ordinary magnetic carrier, such as ferrite or magnetite, or a resin-coated carrier. Alternatively, magnetic material-dispersing resin particles produced by dispersing magnetic material in the resin component or porous magnetic core particles that contain resin in the pores may be used.

Examples of the magnetic material of the magnetic material-dispersing resin particles include magnetite powder, maghemite powder, and magnetic iron oxide powder that is magnetite or maghemite powder containing at least one selected from the group consisting of oxides and hydroxides of silicon and oxides and hydroxides of aluminum; magnetoplumbite ferrite powder containing barium, strontium, or barium-strontium; spinel ferrite containing at least one selected from the group consisting of manganese, nickel, zinc, lithium, and magnesium; and other magnetic iron compound powder.

In addition to such magnetic materials, other powder material may be used in combination with magnetic iron compound powder, and examples include non-magnetic iron oxide powder such as hematite powder, ferric hydroxide-containing non-magnetic powder such as goethite, non-magnetic inorganic compound powder such as titanium oxide powder, silica powder, talc powder, alumina powder, barium sulfate powder, barium carbonate powder, cadmium yellow powder, calcium carbonate powder, and hydrozincite powder.

The material of the porous magnetic core particles may be magnetite or ferrite. Exemplary ferrite is represented by the following formula:

(M1₂O)ₓ(M2O)_{y}(Fe₂O₃)_{Z}

In the formula, M1 represents a monovalent metal, and M2 represents a divalent metal. Also, 0≤(x, y)≤0.8 and 0.2<z<1.0 hold when x+y+z=1.0 holds.

At least one selected from the group consisting of Li, Fe, Mn, Mg, Sr, Cu, Zn, and Ca may be used as M1 or M2. In addition, Ni, Co, Ba, Y, V, Bi, In, Ta, Zr, B, Mo, Na, Sn, Ti, Cr, Al, Si, and rare earth elements may be used.

In some embodiments, the magnetic carrier is a resin-coated carrier including magnetic carrier core particles and resin coating layer over the surfaces of the magnetic carrier core particles. The resin coating layer, for example, coats the surface of the magnetic carrier core particle. The magnetic carrier core particles may be porous magnetic core particles containing resin in the pores.

The resin filling the pores of the porous magnetic core particles may be either a thermoplastic resin or a thermosetting resin.

Examples of the thermoplastic resin include novolac resin, saturated alkyl polyester resin, polyarylate, polyamide resin, and acrylic resin.

Examples of the thermosetting resin include phenol-based resin, epoxy resin, unsaturated polyester resin, and silicone resin.

The coating of the magnetic carrier core particles with resin may be performed, but not limited to, using application techniques, such as dipping, spraying, brush coating, and fluidized bed coating. In some embodiments, dipping may be used.

The amount of the resin coating the surfaces of the magnetic carrier core particles (the amount of resin coating layers) may be 0.1 parts to 5.0 parts by mass relative to 100 parts by mass of the magnetic carrier core particles from the viewpoint of controlling the ability to apply charge to the toner.

Examples of the resin used for the resin coating layer include acrylic resins, such as acrylic ester copolymers and methacrylic ester copolymers; styrene-acrylic resins, such as styrene-acrylic ester copolymers and styrene-methacrylic ester copolymers; and polytetrafluoroethylene, fluorine-containing resins, such as polytetrafluoroethylene, tetrafluoroethylene-hexafluoropropylene copolymer, monochlorotrifluoroethylene polymer, and polyvinylidene fluoride; and silicone resin, polyester resin, polyamide resin, polyvinylbutyral, aminoacrylate resin, ionomer resin, and polyphenylene sulfide resin.

These resins may be used individually or in combination. In some embodiments, acrylic resins are used.

In particular, copolymers containing (math)acrylic esters with alicyclic hydrocarbon groups may be selected from the viewpoint of charge stability. Beneficially, the resin of the resin coating layer contains monomer units of (meth)acrylic ester with alicyclic hydrocarbon groups. In other words, the resin of the resin coating layer contains a polymer of monomers containing (meth)acrylic ester having at least an alicyclic hydrocarbon group.

Favorable examples of the (meth)acrylic ester containing an alicyclic hydrocarbon group include cyclobutyl acrylate, cyclopentyl acrylate, cyclohexyl acrylate, cycloheptyl acrylate, dicyclopentenyl acrylate, dicyclopentanyl acrylate, cyclobutyl methacrylate, cyclopentyl methacrylate, cyclohexyl methacrylate, cycloheptyl methacrylate, dicyclopentenyl methacrylate, and dicyclopentanyl methacrylate.

The alicyclic hydrocarbon groups may have 3 to 10 or 4 to 8 carbon atoms. Such monomers may be used individually or in combination.

The proportion of the monomer units formed by (meth)acrylic ester having alicyclic hydrocarbon groups in the copolymer used for the resin coating layer may be 5.0% to 80.0% by mass, for example, 50.0% to 80.0% by mass or 70.0% to 80.0% by mass. The monomer units in such a proportion range provides good chargeability in high-temperature, high-humidity environments.

Furthermore, the resin in the resin coating layer may contain macromonomers as copolymerization components from the viewpoint of improving adhesion between the magnetic carrier core particles and the resin coating layers to reduce local separation of the resin coating layers in view of charge stability. Formula (B) represents an example of macromonomers. In other words, the resin of the resin coating layer may contain monomer units formed by macromonomers represented by formula (B).

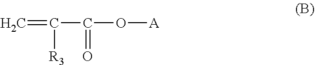

In formula (B), A represents a polymer of at least one compound selected from the group consisting of methyl acrylate, methyl methacrylate, butyl acrylate, butyl methacrylate, 2-ethylhexyl acrylate, 2-ethylhexyl methacrylate, styrene, acrylonitrile, and methacrylonitrile. R³ represents H or CH₃. In some embodiments, A is a polymer of methyl methacrylate.

### Measurements of Physical Properties

Measurement Methods of Physical Properties Will Now be Described. Separation of Fine Particles and Toner Particles from Toner

For measuring physical properties, the fine particles can be separated from the toner by the following method.

A concentrated sucrose solution is prepared by dissolving 200 g of sucrose (produced by Kishida Chemical) in 100 mL of ion-exchanged water being heated in hot water. A dispersion liquid is prepared by adding 31 g of the concentrated sucrose solution and 6 mL of Contaminon N (10 mass % aqueous solution of pH 7 neutral detergent for cleaning precision measuring instruments, containing a nonionic surfactant, an anionic surfactant, and an organic builder, produced by Wako Pure Chemical Corporation) into a centrifuge tube. Then, 1 g of the toner is added into the dispersion liquid, followed by diffusing aggregates of the toner with a spatula or the like.

The centrifuge tube is shaken with a shaker for 20 minutes under the conditions of reciprocally 350 times per minute. After shaking, the liquid is replaced in a glass tube (50 mL) for a swing rotor and centrifuged at 3500 rpm for 30 minutes. After centrifugation, the toner in the glass tube is in the top layer, and the fine particles are in the aqueous solution of the lower layer. The aqueous solution of the lower layer is collected and centrifuged to separate sucrose and fine particles, and the fine particles are collected. If necessary, centrifugation is repeated. After sufficient separation, the dispersion liquid is dried, and fine particles are collected.

If a plurality of external additives is added, the external additive disclosed herein can be separated using centrifugation or the like.

### Measurement of Embedding Rate of Fine Particles B

The composite fine particles are sufficiently dispersed in a visible light-curable resin (Aronix LCR series D-800 (trade name) produced by Toagosei), and the mixture is cured by irradiation with short-wavelength light. The resulting cured product is cut out with an ultramicrotome equipped with a diamond knife to prepare a 250 nm-thick thin sample. Then, the cut sample, that is, the cross section of the composite fine particles, is observed with a transmission electron microscope (JEM-2800 produced by JEOL), TEM-EDX, at a magnification of 40000 to 50000 times. The diameter of the fine particles B and the depth of the fine particles B embedded in fine particles A are measured using the sectional image. Five fine particles B are randomly selected for one composite fine particle, and the embedding rate of the fine particles B is calculated using the following equation. The number of particles analyzed is set to 20 composite fine particles, and their embedding rates of fine particles B are averaged.

$$Embedding rate ( \% ) of the fine particles B = ( depth of the fine particles B embedded in the fine particles A ) / ( diameter of fine particles B ) \times 100$$

### Calculation of Sb/Sa of Composite Fine Particles

The cross-sections of the composite fine particles are observed in the same manner as above, and the Sb/Sa of the composite fine particles is calculated by image analysis. The image analysis software program is, for example, ImageJ. The area Sa of the cross section X of a fine particle A is calculated from the image obtained by the observation, and in the cross section X, the total area Sb of the fine particles B fully contained within the cross section X without being exposed outside is calculated. The number of particles analyzed is set to 100 composite fine particles, and their Sb/Sa values are averaged.

### Calculation of BD/AD of Composite Fine Particles

The cross sections of the composite fine particles are observed in the same manner as above, and BD/AD of the composite fine particles is calculated.

The particle size AD of the fine particles A and the particle size BD of the fine particles B are calculated from the image obtained by the observation. The number of particles analyzed is set to 20 composite fine particles, and their BD/AD values are averaged.

### Determination of Constituent Contents of Composite Fine Particles by Solid-State ²⁹Si-NMR

In solid-state ²⁹Si-NMR, peaks are detected in different shift regions depending on the structure of the functional group, bound to Si, of the constituent compound in the composite fine particles. The structure bound to Si at each peak position is identified using reference samples. Also, the proportions of constituents are calculated from the peak areas. The ratios of the peak areas of M unit structure, D unit structure (c), T unit structure (b), and Q unit structure (a) to the total peak area are calculated.

Specific measurement conditions of solid-state ²⁹Si-NMR are as follows:
Apparatus: JNM-ECX 5002 (JEOL RESONANCE)
Temperature: room temperature
Measurement method: DDMAS ²⁹Si 45°
Sample tube: zirconia, 3.2 mm in diameter
Sample: Powder in the sample tube
Sample rotation speed: 10 kHz
Relaxation delay: 180 s
Scan: 2000

After the measurement, the silane components, different in substituent and linking group, in the sample are subjected to peak separation into the M unit structure, the D unit structure (c), the T unit structure (b), and the Q unit structure (a), represented below, by curve fitting, and their peak areas are calculated.

The curve fitting is performed using software for JNM-EX 400 manufactured by JEOL, Excalibur for Windows (registered trademark) version 4.2 (EX series), as follows: Click “1D Pro” from the menu icon to load the measurement data. Then, select “Curve fitting function” from the “Command” menu bar for curve fitting. Perform curve fitting for each component so that the difference between the composite peak obtained by combining the peaks obtained by curve fitting and the peak of the measurement result (composite peak difference) is the smallest.
M unit structure: (Ra)(Rb)(Rc)SiO_{1/2}
D unit structure: (Rd)(Re)Si(O_{1/2})₂ (c)
T unit structure: RfSi(O_{1/2})₃ (b)
Q unit structure: Si(O_{1/2})₄ (a)

Ra, Rb, Rc, Rd, Re, Rf in the formulas are organic groups with 1 to 6 carbon atoms (e.g., alkyl and alkoxy) and halogen and hydroxy groups bound to silicon. The proportions of (a), (b), and (c) in the external additive are calculated for the peak areas of the structure represented by formula (a), the structure represented by formula (b), and the structure represented by formula (c) obtained by the measurement. If the structures are required to be examined in more detail, identifications may be performed by combining the results of ¹³C-NMR and ¹H-NMR with the results of ²⁹Si-NMR.

### Measurement of Absolute Specific Gravity of Composite Fine Particles

The absolute specific gravity of the composite fine particles is measured with, for example, a dry automatic density meter Autopycnometer (manufactured by Quantachrome Instruments). The measurement conditions are as follows:
Cell: SM cell (10 mL)
Amount of sample: 0.05 g

This measurement method determines the absolute specific gravities of solids and liquids based on gas pycnometry.

Gas pycnometry is based on Archimedes' principle as with liquid pycnometry and is more precise for very small pores because of using gas (argon gas) as the replacement medium.

### Measurement of Number Average Diameter of Particles of External Additive

The numbers and particle sizes (largest sizes) of the composite fine particles and fine particles C at the surfaces of the toner particles can be measured by observing the toner particles under a scanning electron microscope (SEM). At this time, energy dispersive X-ray analysis (EDS) associated with SEM can be used to confirm that the object being measured is the composite fine particles or particles C. Each of the number average diameters of particles is the average of measurements of 100 toner particles.

### Measurement of Volume Resistivity of Fine Particles C

Electrometer/High Resistance System Model 6517, manufacture by Keithley Instruments, can be used for the measurement. Electrodes of 25 mm in diameter are connected. Particles are aggregated to a thickness of about 0.5 mm between the electrodes, and the distance between the electrodes is measured with a load of about 2.0 N applied. The resistance of aggregated particles to which a voltage of 1,000 V is being applied for 1 minute is measured, and the volume resistivity is calculated using the following equation:

$$Volume resistivity ( Ω \cdot cm ) = R \times L$$

R: resistance (Ω)
L: distance (cm) between electrodes

### Measurement of Weight Average Particle Size (D4) of Toner

The weight average particle size (D4) of the toner is measured by a pore electric resistance method with a 100 μm aperture tube, using a precise particle size distribution analyzer “Multisizer 3 Coulter Counter” (registered trademark) manufactured by Beckman Coulter and a dedicated software program Multisizer 3 Version 3. 51 supplied from Beckman Coulter with the analyzer for setting measuring conditions and analyzing measurement data. For the measurement and data analysis, the effective number of measurement channels is set to 25,000.

The electrolyte solution used for the measurement may be prepared by dissolving highest-quality sodium chloride in ion-exchanged water to about 1% by mass, and, for example, ISOTON II (produced by Beckman Coulter, Inc.) may be used.

Before the measurement and analysis, the above-mentioned dedicated software is set up as described below.

On the “standard measurement (SOM) change screen” (translation) of the software, the total count in the control mode is set to 50000 particles; the number of measurements to 1; and Kd to the value obtained using “10.0 μm standard particles” (produced by Beckman Coulter, Inc.). On pressing the threshold/noise level measurement button, the threshold and noise level are automatically set. The Current is set to 1600 μA; the Gain to 2; and the electrolyte solution to ISOTON II. A checkmark is placed at the statement “flush of aperture tube after measurement” (translation).

On the “Pulse-to-Particle Size Conversion Setting Screen (translation)” of the dedicated software, the bin distance is set to logarithmic particle size, the particle size bin to 256 particle size bins, and the particle size range to a range of 2 μm to 60 μm.

Specifically, the measurement is performed according to the following procedure:

(1) About 200 mL of the electrolyte solution is placed in a Multisizer-3-specific 250 mL glass round bottom beaker and stirred with a stirrer rod counterclockwise at 24 revolutions per second with the beaker set on a sample stand. The dirt and air bubbles in the aperture tube are removed by the “Aperture Flush” function of the dedicated software.

(2) About 30 mL of the electrolyte solution is placed in a 100 mL glass flat bottom beaker, and into which is added about 0.3 mL of a dispersant prepared by diluting CONTAMINON N to three times its mass with ion-exchanged water. CONTAMINON N is a 10 mass % aqueous solution of a pH 7 neutral detergent for precision measurement instruments produced by FUJIFILM Wako Pure Chemical Corporation and contains a nonionic surfactant, an anionic surfactant, and an organic builder.

(3) About 2 mL of CONTAMINON N is added to a predetermined amount of ion-exchanged water in a water tank of an ultrasonic dispersion system Tetora 150 (manufactured by Nikkaki Bios) having an electric power of 120 W, containing two oscillators of 50 kHz in oscillation frequency with the phases shifted by 180°.

(4) The beaker of the above (2) is set to a beaker securing hole of the ultrasonic dispersion system, and the ultrasonic dispersion system is started. Then, the height of the beaker is adjusted so that the resonance at the level of the electrolyte solution in the beaker can be largest.

(5) In a state where ultrasonic waves are applied to the electrolyte solution in the beaker of (4), about 10 mg of toner is added little by little to the electrolyte solution and dispersed. Such ultrasonic dispersion is further continued for 60 seconds. For the ultrasonic dispersion, the water temperature in the water tank is controlled in the range of 10° C. to 40° C. as appropriate.

(6) The electrolytic solution of (5), in which the toner is dispersed, is dropped using a pipette into the round bottom beaker of the above (1) set on the sample stand to adjust the measurement concentration to about 5%. Then, the measurement is performed until the number of measured particles reaches 50000.

(7) The measurement data is analyzed with the dedicated software, and the weight average particle size (D4) is calculated. Here, “Average size” on the Analysis/Volume Statistic Value (Arithmetic Mean) screen (translation) in a state where graph/volume % is set in the software program represents the weight average particle size (D4).

### EXAMPLES

The fundamental elements and features of the present disclosure have been described above. The present disclosure will be further described specifically with reference to the following Examples. However, the present disclosure is not limited to the Examples. In the following description, “part(s)” and “%” are on a mass basis unless otherwise specified.

### Preparation of Binder Resin 1

Bisphenol A ethylene oxide (2.2 mol adduct): 50.0 parts by mole
Bisphenol A propylene oxide (2.2 mol adduct): 50.0 parts by mole
Terephthalic acid: 90.0 parts by mole
Trimellitic anhydride: 10.0 parts by mole

The above monomers that form the polyester unit in 100 parts by mass were mixed with 500 ppm of titanium tetrabutoxide in a 5 L autoclave.

The autoclave was then equipped with a reflux condenser, a moisture separator, a N₂ gas inlet tube, a thermometer, and a stirrer, and a condensation polymerization reaction was performed at 230° C. while N₂ gas was introduced into the autoclave. The reaction time was adjusted to obtain a desired softening point, and after the completion of the reaction, the product was removed from the container, cooled, and pulverized to yield binder resin 1 for toner particles. The softening point of binder resin 1 was 130° C., and the glass transition temperature Tg was 57° C.

The softening point was measured as described below.

### Measurement of Softening Point

The softening point is measured with a capillary rheometer of a constant-pressure extrusion system using load, Flow Tester CFT-500D (manufactured by Shimadzu), in accordance with the manual attached to the tester. In this apparatus, the measurement sample in a cylinder is heated to be melted while a constant load is placed on the measurement sample by a piston, and the melted sample is extruded from the cylinder. Thus, by using this apparatus, a rheogram showing the relationship between the downward displacement of the piston and the heating temperature at this time can be prepared.

The melting temperature by the ½ method described in the manual attached to the flow tester CFT-500D is defined as a softening point.

The melting temperature determined by the ½ method is obtained as described below.

First, calculated is a half, X, of the difference between the downward displacement Smax of the piston at the time when the sample has flowed out completely and the downward displacement Smin of the piston at the time when the sample has started flowing (hence, X=(Smax−Smin)/2). The temperature in the rheogram at which the downward displacement of the piston comes to the sum of X and Smin in the rheogram is defined as the melting temperature determined by the ½ method.

For this measurement, about 1.3 g of a sample is compacted into a cylindrical tablet with a diameter of about 8 mm in a tablet forming machine (for example, NT-100H manufactured by NPa System) at about 10 MPa over a period of 60 seconds in an environment of 25° C. This tabled is used as the measurement sample. The measurement using CFT-500D is performed under the following conditions:
Measurement mode: temperature rising
Start temperature: 50° C.
End-point temperature: 200° C.
Measuring intervals: 1.0° C.
Temperature rise rate: 4.0° C./min
Cross-sectional area of piston: 1.000 cm²
Test load (Piston load): 10.0 kgf/cm² (0.9807 MPa)
Preheating time: 300 s
Hole diameter in die: 1.0 mm
Die length: 1.0 mm

### Production Example of Composite Fine Particles 1

### 1. Hydrolysis and Condensation Polymerization Step:

(1) Into a 500 mL beaker, 21.6 g of RO water, 135.0 g of methanol, 0.004 g of acetic acid as a catalyst, and 12.2 g of dimethyldimethoxysilane were added and stirred at 45° C. for 5 minutes.

(2) To the resulting mixture, 2.0 g of 28% ammonia water, 15.0 g of tetraethoxysilane, and 5.0 g of colloidal silica aqueous dispersion liquid A (40% by mass of silica solids, number average diameter of particles of silica: 40 nm (0.04 μm)) were added and stirred at 30° C. for 3.0 hours to yield a raw solution.

### 2. Particle Formation Step:

RO water weighing 120.0 g was poured into 1000 mL beaker, and the raw material solution obtained in the above hydrolysis and condensation polymerization step was dropped over 5 minutes while the RO water is stirred at 25° C. Subsequently, the resulting mixture was heated to 60° C. and stirred for 1.5 hours with the temperature kept at 60° C. to yield a dispersion liquid of external additive fine particles.

### 3. Hydrophobization Step:

Hexamethyldisilazane weighing 6.0 g as a hydrophobizing agent was added to the dispersion liquid of the external fine particles obtained through the particle formation step and stirred at 60° C. for 3.0 hours. The dispersion was allowed to stand still for 5 minutes to settle powder under the solution. The settled powder was collected by suction filtration and dried at 120° C. for 24 hours under reduced pressure to yield composite fine particles 1. The number average diameter of primary particles of composite fine particles 1 was 0.12 μm.

### Production Example of Composite Fine Particles 2

Composite fine particles 2 were produced in the same manner as in the production example of composite fine particles 1, except that 27.2 g of trimethoxymethylsilane was added instead of dimethyldimethoxysilane added in (1) of the above hydrolysis and polycondensation step, and tetraethoxysilane was not added in (2).

### Production Example of Composite Fine Particles 3

Composite fine particles 3 were produced in the same manner as in the production example of composite fine particles 1, except that in the hydrolysis and polycondensation step described above, the amount of dimethyldimethoxysilane was changed to 5.4 g in (1), the amount of tetraethoxysilane was changed to 8.2 g in (2), and 13.6 g of trimethoxymethylsilane was added.

### Production Example of Composite Fine Particles 4

Composite fine particles 4 were produced in the same manner as in the production example of composite fine particles 1, except that alumina aqueous dispersion liquid (30% by mass of alumina solids, number average diameter of particles of alumina: 40 nm (0.04 μm)) was used instead of colloidal silica aqueous dispersion liquid A in (2) of the above hydrolysis and polycondensation step.

### Production Example of Composite Fine Particles 5

Composite fine particles 5 were produced in the same manner as in the production example of composite particle 1, except that in the hydrolysis and polycondensation step describe above, the amount of dimethyldimethoxysilane was changed to 5.4 g in (1), tetraethoxysilane added in (2) was not added, and 21.8 g of trimethoxymethylsilane was added.

### Production Example of Composite Fine Particles 6

Composite fine particles 6 were produced in the same manner as in the production example of composite fine particles 1, except that the amount of colloidal silica aqueous dispersion liquid A was changed to 10.0 g in (2) of the above hydrolysis and polycondensation step.

### Production Example of Composite Fine Particles 7

Composite fine particles 7 were produced in the same manner as in the production example of composite fine particles 1, except that in (2) of the hydrolysis and polycondensation step described above, the amount of 28% ammonia water was changed to 1.0 g, and the stirring temperature was changed to 40° C.

### Production Example of Composite Fine Particles 8

Composite fine particles 8 were produced in the same manner as in the production example of composite fine particles 1, except that in (2) of the hydrolysis and polycondensation step described above, colloidal silica aqueous dispersion liquid B (40% by mass silica solids, number average diameter of particles of silica: 20 nm (0.02 μm)) was used instead of colloidal silica aqueous dispersion liquid A, the amount of 28% ammonia water was changed to 3.0 g, and the stirring temperature was changed to 25° C.

### Production Example of Composite Fine Particles 9

Composite fine particles 9 were produced in the same manner as in the production example of composite fine particles 1, except that in (2) of the hydrolysis and polycondensation step described above, colloidal silica aqueous dispersion liquid C (40% by mass of silica solids, number average diameter of particles of silica: 10 nm (0.01 μm)) was used instead of colloidal silica aqueous dispersion liquid A, the amount of 28% ammonia water was changed to 3.0 g, and the stirring temperature was changed to 25° C.

### Production Example of Composite Fine Particles 10

Composite fine particles 10 were produced in the same manner as in the production example of composite fine particles 1, except that in (2) of the hydrolysis and polycondensation step described above, the amount of 28% ammonia water was changed to 1.0 g, the stirring temperature was changed to 40° C., and the stirring time was changed to 3.5 hours.

### Production Example of Composite Fine Particles 11

Composite fine particles 11 were produced in the same manner as in the production example of composite fine particles 1, except that in (2) of the hydrolysis and polycondensation step described above, colloidal silica aqueous dispersion liquid C (40% by mass of silica solids, number average diameter of particles of silica: 10 nm (0.01 μm)) was used instead of colloidal silica aqueous dispersion liquid A, the amount of 28% ammonia water was changed to 1.0 g, the stirring temperature was changed to 45° C., and the stirring time was changed to 4.0 hours.

### Production Example of Composite Fine Particles 12

Composite fine particles 12 were produced in the same manner as in the production example of composite fine particles 1, except that in (2) of the hydrolysis and polycondensation step described above, the amount of 28% ammonia water was changed to 5.0 g, the stirring temperature was changed to 25° C., and the stirring time was changed to 2.0 hours.

### Production Example of Composite Fine Particles 13

In a 250 mL four-neck round-bottom flask equipped with an overhead stirring motor, a condenser, and a thermocouple, 18.7 g colloidal silica dispersion liquid (40% by mass of silica solids, number average diameter of particles of silica: 30 nm (0.03 μm)), 125 mL of DI water, and 16.5 g (0.066 mol) of methacryloxypropyltrimethoxysilane were added. The temperature was increased to 65° C., and the mixture was stirred at 120 rpm. The mixture was bubbled for 30 minutes by introducing nitrogen gas into the mixture. After 3 hours, 0.16 g of 2,2′-azobisisobutyronitrile radical initiator dissolved in 10 mL of ethanol was added, and the temperature was increased to 75° C.

Radically polymerizable was allowed to proceed for 5 hours, and subsequently, 3 mL of 1,1,1,3,3,3-hexamethyldisilazane was added to the mixture. The reaction was allowed to proceed over another 3 hours. The final mixture was filtered through a 170 mesh sieve to remove solidified matter, and the resulting dispersion was dried at 120° C. in a Pyres (registered trademark) dish overnight to yield composite fine particles 13.

The physical properties of composite fine particles 1 to 13 are presented in Table 1.

TABLE 1

| | | | | | | | | (3) | | Fine | | | |
|---|---|---|---|---|---|---|---|---|---|---|---|---|---|
| | | Absolute | | | | (1) | | Pa/ | | particles B | | | |
| Composite | Particle | specific | Fine particles A | | | Pa + | (2) | (Pa + | | Particle | Embedding | | |
| fine | size | gravity | Structural proportions | | | Pb + | Pb + | Pb + | Fine | size | rate | | |
| particles | μm | g/cm³ | (a) | (b) | (c) | Pc | Pc | Pc) | particles B | μm | % | Sb/Sa | BD/AD |
| 1 | 0.12 | 1.35 | 0.45 | 0.00 | 0.55 | 1.00 | 0.55 | 0.45 | Silica | 0.04 | 65 | 0.25 | 0.33 |
| 2 | 0.12 | 1.35 | 0.00 | 1.00 | 0.00 | 1.00 | 1.00 | 0.00 | Silica | 0.04 | 65 | 0.25 | 0.33 |
| 3 | 0.12 | 1.35 | 0.30 | 0.50 | 0.20 | 1.00 | 0.70 | 0.30 | Silica | 0.04 | 65 | 0.25 | 0.33 |
| 4 | 0.12 | 1.35 | 0.45 | 0.00 | 0.55 | 1.00 | 0.55 | 0.45 | Alumina | 0.04 | 65 | 0.25 | 0.33 |
| 5 | 0.12 | 1.35 | 0.00 | 0.80 | 0.20 | 1.00 | 1.00 | 0.00 | Silica | 0.04 | 65 | 0.48 | 0.33 |
| 6 | 0.12 | 1.55 | 0.45 | 0.00 | 0.55 | 1.00 | 0.55 | 0.45 | Silica | 0.04 | 65 | 0.25 | 0.33 |
| 7 | 0.06 | 1.35 | 0.45 | 0.00 | 0.55 | 1.00 | 0.55 | 0.45 | Silica | 0.04 | 65 | 0.25 | 0.67 |
| 8 | 0.30 | 1.35 | 0.45 | 0.00 | 0.55 | 1.00 | 0.55 | 0.45 | Silica | 0.02 | 65 | 0.25 | 0.07 |
| 9 | 0.30 | 1.35 | 0.45 | 0.00 | 0.55 | 1.00 | 0.55 | 0.45 | Silica | 0.01 | 65 | 0.25 | 0.03 |
| 10 | 0.05 | 1.35 | 0.45 | 0.00 | 0.55 | 1.00 | 0.55 | 0.45 | Silica | 0.04 | 65 | 0.25 | 0.80 |
| 11 | 0.02 | 1.35 | 0.45 | 0.00 | 0.55 | 1.00 | 0.55 | 0.45 | Silica | 0.01 | 20 | 0.25 | 0.50 |
| 12 | 0.33 | 1.35 | 0.45 | 0.00 | 0.55 | 1.00 | 0.55 | 0.45 | Silica | 0.04 | 65 | 0.25 | 0.12 |
| 13 | 0.12 | 1.50 | — | — | — | — | — | — | Silica | 0.04 | 65 | 0.85 | 0.33 |

### Production Example of Fine Particles C1

Hydrous titanium oxide slurry prepared by hydrolyzing a titanyl sulfate aqueous solution was washed with an alkaline aqueous solution until the electrical conductivity of the supernatant liquor reached 50 S/cm to reduce impurities for purification. Then, hydrochloric acid was added to the hydrous titanium oxide slurry to adjust the pH to 0.7 to obtain a titania sol dispersion liquid.

Strontium chloride aqueous solution was added to 2.2 mol (in terms of titanium dioxide) of the titania sol dispersion liquid in an amount of 1.3 times the moles of the titania sol dispersion liquid, and the mixture was placed into a reaction vessel, followed by nitrogen purging. Additionally, pure water was added so that the concentration of the dispersion liquid in terms of titanium oxide came to 1.1 mol/L.

After stirring and mixing the contents in the reaction vessel and heating the contents to 90° C., 440 mL of 10 N sodium hydroxide aqueous solution was added over 15 minutes with ultrasonic vibration, followed by a reaction for 20 minutes. After the reaction, pure water of 5° C. was added to the slurry to rapidly cool the slurry to 30° C. or less, and then, the supernatant liquor was removed. Furthermore, hydrochloric acid aqueous solution with a pH of 5.0 was added to the slurry, and the slurry was stirred for 1 hour to dissolve and remove strontium carbonate, followed by repeated washing with pure water.

Then, after adding hydrochloric acid aqueous solution with a pH of 3.0 to the slurry, 7.0 parts by mass of isobutyltrimethoxysilane was added to 100 parts by mass of solids in the slurry, followed by stirring for 10 hours. The contents in the reaction vessel were then neutralized with a sodium hydroxide aqueous solution, filtered through a nutsche, and washed with pure water. The resulting cake was dried to yield fine particles C1. The physical properties are presented in Table 2.

### Production Examples of Fine Particles C2 to C8

Fine particles C2 to C8 were produced in the same manner as in the production example of fine particles C1, except that the production conditions were varied so that the number average diameters of particles were as presented in Table 2 and the amount of isobutyltrimethoxysilane added was adjusted.

TABLE 2

| | Number average | Highest | Silane | |
|---|---|---|---|---|
| Fine | diameter | peak (a) | compound | Volume |
| particles | of particles | Half width | (parts | resistivity |
| C | (nm) | (deg) | by mass) | (Ω · cm) |
| 1 | 35 | 0.33 | 7 | 2.0 × 10¹⁰ |
| 2 | 20 | 0.36 | 13 | 2.5 × 10¹⁰ |
| 3 | 50 | 0.28 | 10 | 3.5 × 10¹¹ |
| 4 | 50 | 0.50 | 12 | 1.2 × 10¹² |
| 5 | 50 | 0.23 | 14 | 4.7 × 10¹² |
| 6 | 60 | 0.21 | 16 | 1.4 × 10¹³ |
| 7 | 100 | 0.18 | 16 | 1.2 × 10¹³ |
| 8 | 110 | 0.55 | 17 | 5.0 × 10¹³ |

### Production Example of Fine Particles C9

Ilmenite ore containing 50% by mass of TiO₂ equivalent was used as the starting material. The starting material was dried at 150° C. for 2 hours and then dissolved by adding sulfuric acid to prepare a TiOSO₂ aqueous solution. The resulting aqueous solution was neutralized with an alkali to pH 9.0 by adding sodium carbonate and filtered to obtain a white precipitate. The white precipitate was hydrolyzed by adding pure water to the precipitate and heat-treated for 2.5 hours with the temperature kept at about 90° C., followed by repeating filtration and washing with water to obtain anatase titanium dioxide.

The resulting anatase titanium dioxide was sintered by heating at a high temperature of 1100° C. to obtain rutile titanium dioxide. The rutile titanium dioxide was crushed with a jet mill to obtain titanium dioxide fine particles. The resulting titanium dioxide fine particles were dispersed in ethanol, and 5 parts by mass of isobutyltrimethoxysilane solids as a hydrophobizing agent were dropped into and mixed with 100 parts by mass of the dispersion of the titanium oxide fine particles with sufficient stirring to prevent particle agglomeration, thus performing a reaction for hydrophobization treatment.

The pH of the slurry was adjusted to 6.5 with further sufficient stirring. After the slurry was filtered and dried, the resulting matter was heat-treated at 170° C. for 2 hours and then repeatedly crushed with a jet mill until aggregates of titanium oxide were eliminated to yield fine particles C9.

Fine particles C9 had a volume resistivity of 2.0×10⁹ Ω·cm and a number average diameter of primary particles of 30 nm.

### Production Example of Fine Particles C10

Titanium tetraisopropoxide, which was used as the raw material, was delivered little by little to the glass wool in a vaporizer heated to about 200° C. with a chemical pump using nitrogen gas as a carrier gas to evaporate, followed by instantaneous thermal decomposition at about 300° C. in the reactor and rapid cooling, and thus, the product was collected. Furthermore, the resulting product was fired at about 300° C. for 2 hours and pulverized in a jet mill to obtain titanium oxide.

In 100 parts by mass of water, 52 parts by mass of the above titanium dioxide and 48 parts by mass of calcium carbonate were dispersed and mixed well. The mixture was heat-treated at about 1000° C. to obtain calcium titanate fine particles.

The resulting calcium titanate fine particles were dispersed in ethanol, and 3 parts by mass of isobutyltrimethoxysilane solids as a hydrophobizing agent were dropped into and mixed with 100 parts by mass of the dispersion of calcium titanate fine particles with sufficient stirring to prevent particle agglomeration, thus performing a reaction for hydrophobization treatment.

The pH of the slurry was adjusted to 6.5 with further sufficient stirring. After the slurry was filtered and dried, the resulting matter was heat-treated at 170° C. for 2 hours and then repeatedly crushed with a jet mill until aggregates of calcium titanate fine particles were eliminated to yield fine particles C10.

Fine particles C10 had a volume resistivity of 3.6×10¹³ Ω·cm and a number average diameter of primary particles of 60 nm.

### Production Example of Toner 1

Binder Resin 1: 100 parts by mass
Paraffin wax (78° C. in melting point): 4 parts by mass
C.I. Pigment Blue 15:3: 4 parts by mass

The above materials were premixed with an Henschel mixer (trade name: FM-10C manufactured by Nippon Coke & Engineering), and then, the mixture was melted and kneaded at 160° C. with a twin-screw extruder.

The resulting kneaded product was cooled and roughly crushed with a hammer mill and then pulverized with a turbo mill.

The pulverized product was sized with a multi-classification classifier using the Coanda effect to obtain toner base particles 1 with a weight average particle size (D4) of 6.5 μm.

Toner base particles 1 were subjected to the following external addition.
Toner base particles 1: 100 parts by mass
Composite fine particles 1: 8.0 parts by mass
Fine particles C1: 1.3 parts by mass

The above materials were mixed with a Henschel mixer (model name: FM-10C, manufactured by Nippon Coke Co., Ltd.) at a rotational speed of 67 s⁻¹ (4000 rpm), a rotation time of 2 min, and an external addition temperature of room temperature, and the mixture was passed through an ultrasonic vibrating sieve with opening of 54 μm to yield toner 1.

### Preparation Examples of Toners 2 to 16

Toners 2 to 16 were produced in the same manner as in the production example of Toner 1, except that the formulations and conditions for the external additives and their amounts added were as presented in Table 3.

TABLE 3

| | | Composite fine | Fine | Fine particles | | |
|---|---|---|---|---|---|---|
| Toner | Composite fine | particles amount | particles | C amount | Fine particle | |
| No. | particles No. | (parts by mass) | C No. | (parts by mass) | C material | X/Y |
| 1 | 1 | 8.0 | 1 | 1.3 | Strontium titanate | 3.4 |
| 2 | 2 | 8.0 | 1 | 1.3 | Strontium titanate | 3.4 |
| 3 | 3 | 2.0 | 2 | 0.2 | Strontium titanate | 6.0 |
| 4 | 4 | 9.0 | 3 | 1.4 | Strontium titanate | 2.4 |
| 5 | 5 | 1.0 | 3 | 0.05 | Strontium titanate | 2.4 |
| 6 | 5 | 10.0 | 3 | 2.0 | Strontium titanate | 2.4 |
| 7 | 6 | 10.0 | 4 | 2.0 | Strontium titanate | 2.4 |
| 8 | 6 | 10.0 | 5 | 2.0 | Strontium titanate | 2.4 |
| 9 | 7 | 15.0 | 6 | 0.03 | Strontium titanate | 1.0 |
| 10 | 8 | 0.5 | 7 | 2.2 | Strontium titanate | 3.0 |
| 11 | 8 | 0.5 | 10 | 2.2 | Calcium titanate | 5.0 |
| 12 | 9 | 20.0 | 9 | 2.2 | Titanium oxide | 10.0 |
| 13 | 10 | 0.1 | 9 | 2.2 | Titanium oxide | 1.7 |
| 14 | 11 | 0.1 | 8 | 2.2 | Strontium titanate | 0.2 |
| 15 | 12 | 22.0 | 2 | 2.2 | Strontium titanate | 16.5 |
| 16 | 13 | 10.0 | 8 | 2.2 | Strontium titanate | 1.1 |

### Production Example of Carrier 1

Magnetite 1 with a number average diameter of particles of 0.30 μm (magnetization intensity of 65 Am²/kg under a magnetic field of 1000/4π (kA/m))
Magnetite 2 with a number average diameter of particles of 0.50 μm (magnetization intensity of 65 Am²/kg under a magnetic field of 1000/4π (kA/m))

The fine particles of each of the above magnetites were treated by adding 4.0 parts of a silane compound ([3-(2-aminoethylamino)propyl]trimethoxysilane) to 100 parts of the fine particles and mixing by high-speed stirring at 100° C. or more in a vessel.
Phenol: 10% by mass
Formaldehyde solution (40% by mass of formaldehyde, 10% by mass of methanol, 50% by mass of water): 6% by mass
Magnetite 1 treated with the above silane compound: 58% by mass
Magnetite 2 treated with the above silane compound: 26% by mass

In a flask were placed 100 parts of the above materials, 5 parts of 28 mass % ammonia solution, and 20 parts of water, and the temperature was raised to 85° C. over 30 minutes with stirring and mixing. With the temperature held, a polymerization reaction was performed for 3 hours to cure the phenolic resin that was produced. After the cured phenol resin was cooled to 30° C., water was added to the resin, and then the supernatant liquor was removed. The sediment was rinsed with water and dried in the air. Then, the resulting substance was dried at 60° C. under reduced pressure (5 mmHg or less) to yield magnetic material-dispersing spherical carrier 1. The volume average median particle size (D50) was 34.2 μm.

### Example 1

### Preparation of Two-Component Developer 1

Toner 1 and carrier 1 were introduced into a V-blender (V-10, manufactured by Tokuju Corporation) in a proportion in which the toner content was 8.0% by mass and mixed at 0.5 s⁻¹ and a rotation time of 5 min to prepare two-component developer 1.

### Evaluation

The resulting two-component developer 1 was evaluated using the following image forming apparatus. Two-component developer 1 was rated A in any examination.

Two-component developer 1 was placed in the cyan developer of an imaging device, Canon full-color copier imageRUNNER ADVANCE C5560 modified (copy speed: A4 60 sheets/minute), the cyan toner bottle was filled with toner 1, and thus, evaluation as described below was performed.

For evaluation, white paper sheets (product code: CS-814, A4, 81.4 g/m²), available from Canon Marketing Japan, were used as the test paper.

### Evaluation of Toner Scattering

After FFH output charts with an image ratio of 30% were output 100,000 sheets in a high-temperature, high-humidity environment (30° C., 80% RH), the image forming apparatus was left for 24 hours. Then, after FFH output charts with an image ratio of 70% were output 5000 sheets in the same environment, the degree of toner scattering inside the image forming apparatus was visually observed.
A: scattering was hardly observed.
B: Some scattering was observed only around the supply port.
C: Scattering was observed around the supply port and its vicinity.
D: The toner was scattered around the supply port and its vicinity and also slightly to part of the intermediate transfer member.
E: The toner was scattered around the supply port and its vicinity and also to part of the intermediate transfer member.
   (However, neither of these levels is at a degree that the toner would scatter outside the copier.)

### Evaluation of Dot Reproductivity

Dot reproducibility was evaluated by printing an isolated 1-dot halftone image on a A4 sheet after outputting FFH output charts with an image ratio of 30% 100,000 sheets in a high temperature, high humidity environment. The area of 1000 dots in the image was measured with a digital microscope VHX-500 (Wide-range zoom lens VH-Z100, manufactured by Keyence). The number average dot area (S) and the standard deviation (σ) of the dot area were calculated, and the dot reproduction index was calculated using the following equation.

$$Dot reproduction index ( I ) = σ / S \times 100$$

The smaller the dot reproduction index (I), the better the dot reproducibility.
A: I was less than 2.0.
B: I was 2.0 to less than 3.0.
C: I was 3.0 to less than 5.0.
D: I was 5.0 to less than 7.0.

### Examples 2 to 13, Comparative Examples 1 to 3

### Preparation of Two-Component Developers 2 to 11

Two-component developers 2 to 13 were prepared in the same manner as two-component development 1, except that toner 1 was replaced with toners 2 to 13.

Then, evaluations were performed in the same manner, as in Example 1, except for using two-component developments 2 to 13.

The results are presented in Table 4.

TABLE 4

| | | | Dot |
|---|---|---|---|
| Example No. | Toner No. | Toner scattering | reproductivity |
| Example 1 | 1 | A | A (1.4) |
| Example 2 | 2 | A | A (1.5) |
| Example 3 | 3 | A | A (1.5) |
| Example 4 | 4 | A | A (1.8) |
| Example 5 | 5 | A | B (2.2) |
| Example 6 | 6 | A | B (2.2) |
| Example 7 | 7 | B | B (2.5) |
| Example 8 | 8 | B | B (2.6) |
| Example 9 | 9 | B | C (3.5) |
| Example 10 | 10 | B | C (3.6) |
| Example 11 | 11 | B | C (3.6) |
| Example 12 | 12 | C | C (4.3) |
| Example 13 | 13 | C | C (4.7) |
| Comparative Example 1 | 14 | C | D (5.5) |
| Comparative Example 2 | 15 | E | D (5.8) |
| Comparative Example 3 | 16 | D | D (6.2) |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-173998 filed Oct. 6, 2023, which is hereby incorporated by reference herein in its entirety.

What is claimed is:

1. A toner comprising:
toner particles; and
an external additive on the surfaces of the toner particles,
the external additive including:
composite fine particles that include fine particles A containing an organosilicon compound with siloxane bonds as a binder component, and fine particles B, at the surfaces of the composite fine particles, in a state at least partially embedded in the surfaces of the fine particles A, and
fine particles C including either titanium oxide fine particles or titanic acid compound fine particles and having a volume resistivity of 2.0×10⁹ Ω·cm to 2.0×10¹³ Ω·cm and a number average diameter of primary particles of 10 nm to 100 nm,
the fine particles A satisfying the following relationships (1) to (3):
$$P a + P b + P c \geq 0.8 ; \qquad ( 1 )$$
$$Pb + P c \geq 0.3 ; and \qquad ( 2 )$$
$$P a / ( P a + Pb + Pc ) \leq 0.7 , \qquad ( 3 )$$
wherein
Pa represents the proportion of silicon atoms expressed as Si^{a} in the structure represented by the following unit (a) relative to the total silicon atoms contained in the organosilicon compound,
Pb represents the proportion of silicon atoms expressed as Si^{b} in the structure represented by the following unit (b) relative to the total silicon atoms contained in the organosilicon compound, and
Pc represents the proportion of silicon atoms expressed as Si^{c} in the structure represented by the following unit (c) relative to the total silicon atoms contained in the organosilicon compound: 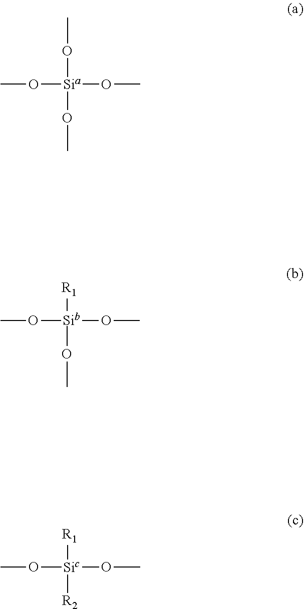
wherein R₁ and R₂ each represent an alkyl group with 1 to 6 carbon atoms,
wherein the average of the embedding rate of the fine particles B in the fine particles A represented by the following equation is 30% to 90%:
embedding rate (%) of the fine particles B=(depth of the fine particles B embedded in the fine particles A)/(diameter of fine particles B)×100, and
wherein the number average diameter X of primary particles of the composite fine particles and the number average diameter Y of primary particles of the fine particles C satisfy the relationship:
$$1. 0 \leq X / Y \leq 10.0 .$$

2. The toner according to claim 1, wherein the number average diameter of primary particles of the composite fine particles is 0.03 μm to 0.30 μm.

3. The toner according to claim 1, wherein the ratio BD/AD of the number average diameter BD of primary particles of the fine particles B to the number average diameter AD of primary particles of the fine particles A is in the range of 0.05 to 0.70.

4. The toner according to claim 1, wherein the fine particles A have an absolute specific gravity of 1.00 g/cm³ to 1.60 g/cm³.

5. The toner according to claim 1, wherein for an electron micrograph of cross sections of the fine particles A taken using a transmission electron microscope, the average of Sb/Sa values of 100 fine particles A is 0 to 0.50, wherein Sa is the area of cross section X of an individual fine particle A, and Sb is the total area of the fine particles B fully contained within the cross section X without being exposed outside.

6. The toner according to claim 1, wherein the fine particles B are silica fine particles or alumina fine particles.

7. The toner according to claim 1, wherein the fine particles C are titanic acid compound fine particles.

8. The toner according to claim 1, wherein the fine particles C contain strontium titanate and exhibit a CuKα X-ray diffraction spectrum having the highest peak at a diffraction angle 2θ of 32.00 degrees to 32.40 degrees, and the highest peak has a half width of 0.23 degrees to 0.50 degrees.

9. The toner according to claim 1, wherein the amount of the fine particles C is 0.05 parts to 2.0 parts by mass relative to 100 parts by mass of the toner particles.
